(19) United States
(12) Patent Application Publication
(10) Pub. No.: US 2008/0006727 A1
(43) Pub. Date: Jan. 10, 2008

(54) Undercarriage washer

(75) Inventor: Warren E. Roh, Monument, CO (US)

Correspondence Address: LAW OFFICE OF DALE B. HALLING, LLC, 655 SOUTHPOINTE CT, SUITE 100, COLORADO SPRINGS, CO, 80906, US

(73) Assignee: Practical Products, Inc.

(21) Appl. No.: 11/827,130

(22) Filed: Jul. 10, 2007

Related U.S. Application Data
(60) Provisional application No. 60/819,594, filed on Jul. 10, 2006.

(51) Int. Cl. B08B 3/00; A62C 31/24; B05B 7/30; B05B 15/06; B05B 3/18

(52) U.S. Cl. 239/754; 239/722; 239/280; 239/318; 239/532; 134/123

(57) ABSTRACT

An undercarriage washer has a handle. A trigger valve is incorporated into the handle. A pipe connects the handle to a reaction driven maneuvering head. A spray nozzle is attached to the maneuvering head. The handle has an inlet that can be connected either to an ordinary garden hose or to a pressure washer. The washer allows a user to stand upright and place the spray nozzle beneath the undercarriage of a vehicle. The reaction driven maneuvering head allows the user to use the force from the spray nozzle to effortlessly move the spray nozzle into any position the user desires.

### RELATED APPLICATIONS

The present application claims priority on the provisional patent application entitled, “Under Surface Washer”, Application No. 60/819,594, filed on Jul. 10, 2006 and is hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

Car, trucks and other vehicles collect dirt, salts and corrosive chemicals in their undercarriages. The salts and corrosive chemicals can result in rusting and other damage to the vehicle if they are not removed. While some drive through car washes have undercarriage sprayers, these sprayers tend to be fixed and cannot be directed to specific problem areas. As a result, not all the salts and corrosive chemicals are removed.

Thus there exists a need for an undercarriage washer that is easy to use and more thoroughly removes the salts, dirt and corrosive chemicals from the underside of a vehicle.

### BRIEF SUMMARY OF INVENTION

An undercarriage washer that overcomes these and other problems has a handle. A trigger valve is incorporated into the handle. A pipe connects the handle to a reaction driven maneuvering head. A spray nozzle is attached to the maneuvering head. The handle has an inlet that can be connected either to an ordinary garden hose or to a pressure washer. The washer allows a user to stand upright and place the spray nozzle beneath the undercarriage of a vehicle. The reaction driven maneuvering head allows the user to use the force from the spray nozzle to effortlessly move the spray nozzle into any position the user desires. This allows the user to concentrate the spray into problem areas and to continue washing the area until they see that all the dirt and debris is removed. As a result, the undercarriage washer is easy to use and more thoroughly removes the salts, dirt and corrosive chemicals from the underside of a vehicle.

### BRIEF DESCRIPTION OF THE SEVERAL VIEWS OF THE DRAWINGS

FIG. 1 is a side view of the undercarriage washer in accordance with one embodiment of the invention;

FIG. 2 is a side view of the undercarriage washer in use in accordance with one embodiment of the invention;

FIG. 3 is a side view of the maneuvering head in accordance with one embodiment of the invention; and

FIG. 4 is a side view of the maneuvering head in accordance with one embodiment of the invention.

### DETAILED DESCRIPTION OF THE INVENTION

The present invention is directed to an undercarriage washer that has a handle. A trigger valve is incorporated into the handle. A pipe connects the handle to a reaction driven maneuvering head. A spray nozzle is attached to the maneuvering head. The handle has an inlet that can be connected either to an ordinary garden hose or to a pressure washer. The washer allows a user to stand upright and place the spray nozzle beneath the undercarriage of a vehicle. The reaction driven maneuvering head allows the user to use the force from the spray nozzle to effortlessly move the spray nozzle into any position the user desires. This allows the user to concentrate the spray into problem areas and to continue washing the area until they see that all the dirt and debris to removed. As a result, the undercarriage washer is easy to use and more thoroughly removes the salts, dirt and corrosive chemicals from the underside of a vehicle.

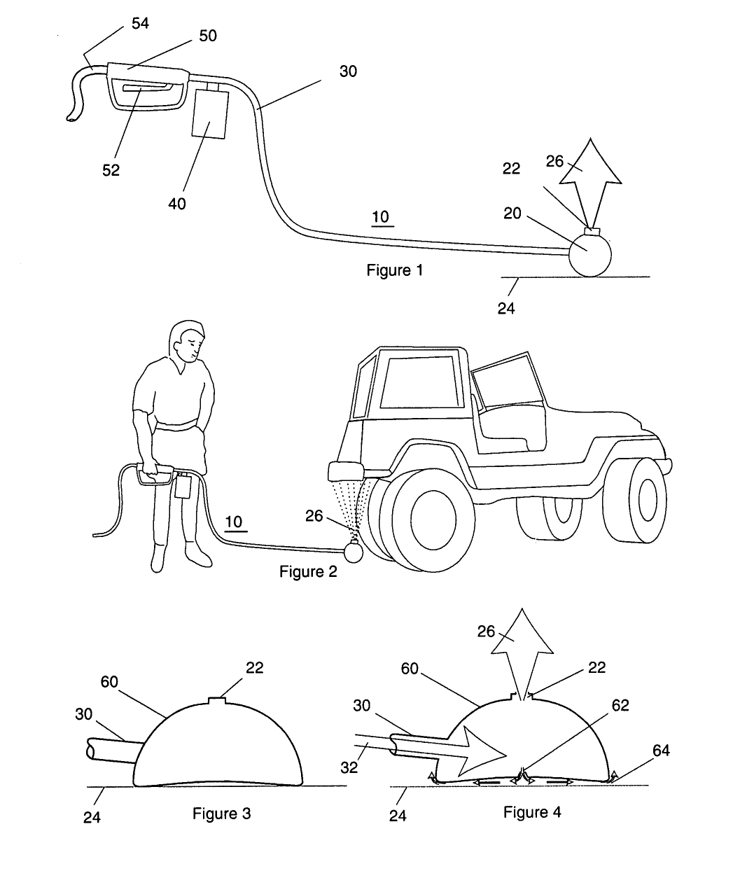

FIG. 1 is a side view of the undercarriage washer 10 in accordance with one embodiment of the invention. The undercarriage washer 10 has a maneuvering head 20 attached to a spray nozzle 22. The maneuvering head 20 rests on surface 24 such as a roadway or driveway. An arrow 26 shows the direction of the water or other mixture leaving the spray nozzle 22. A pipe 30 has a second end 32 connected to an inlet 28 of the maneuvering head 20. A second end 34 of the pipe 30 is connected to an additive container 40 and to a handle 50. The handle 50 has a trigger valve 52 incorporated into the handle 50. The handle 50 has an inlet 53 that can be attached to an ordinary garden hose 54 or the hose from a pressure washer. Note that the pipe 30 has an “S” shape that makes it easy for a user to stand upright and get the nozzle 22 and maneuvering head 20 under the vehicle (See FIG. 2). The maneuver head 20 is a sphere in one embodiment and made of a low friction material such as a hard plastic. This allows the maneuvering head 20 to slide along the surface 24. The force from the water 26 exiting the nozzle 20 can then be used to drive the maneuvering head into any location the user desires. Note that the inlet 28 for the pipe is essentially orthogonal to the spray nozzle 22. This is useful in allowing the user to just tip the nozzle in one direction or another and drive the maneuvering head 20 in the opposite direction. The spray nozzle 22 may be formed into the maneuvering head 20 or may be a separate attachment.

As described herein a “reaction driven maneuvering head” is a maneuvering head that does not have wheels to move the location of the spray nozzle.

FIG. 2 is a side view of the undercarriage washer in use in accordance with one embodiment of the invention. This figure illustrates that the user may stand upright while spraying under the vehicle. The shape (“S” shape) and length of the pipe 30 allows the user to position maneuvering head 20 (FIG. 1) or 60 (FIGS. 3 and 4) under the vehicle while standing in a nearly erect posture. Pipe 30 is sized and shaped to allow the user to reach beneath a large portion of the vehicle without substantially stooping or bending. Although not illustrated, pipe 30's length may be adjustable in telescoping segments to allow invention 10 to be stored or adapted to a length and shape required by the spraying job at hand.

FIG. 3 is a side view of the maneuvering head 60 in accordance with one embodiment of the invention. In this embodiment, maneuvering head 60 is illustrated as a hemispheroid, which is attached to pipe 30, thus replacing maneuvering head 20 in FIG. 1. Maneuvering head 60 may be shaped differently and is only drawn as a hemispheroid for convenience of illustration. In this figure, it can be assumed that valve 50 is shut off and that no liquid is being applied through pipe 30. Therefore, no spray is flowing from nozzle 22 or drive nozzle(s) 62, and maneuvering head 60 is resting against surface 24.

FIG. 4 is a side view of the maneuvering head in accordance with one embodiment of the invention. When trigger 50 is activated and liquid flows through pipe 30 as illustrated by arrow 32, maneuvering head 60 pressurizes and vents through spray nozzle 22 as shown by spray jet arrow 26. A finite amount of liquid also vents though drive nozzle(s) 62. The bottom or underside of maneuvering head 60 is shaped such as to act as a surface propulsion vehicle on land, similar to a hovercraft on water. The only difference being that maneuvering head 60 is hovering on a bearing of liquid instead of air. The small arrows shown exiting nozzle 62 and flowing out and away from maneuvering head 60 illustrate how the liquid levitates head 60 as indicated by gap 64. When levitated by the liquid escaping from beneath head 60's outer edges, a near frictionless liquid bearing is created. This liquid bearing allows the user of the invention 10 to effortlessly control X and Y axis movement of maneuvering head 60 and thus the spray jet. It should be noted that nozzle(s) 62 may be a one or a plurality of nozzles as needed to create a water bearing adequate to support maneuvering head 60. This maneuvering head 60 may be controlled by light lateral forces from its user. In one embodiment, the nozzle 22 is mounted on a pivot point. This is another way to provide reactive steering for a “hover” type maneuvering head 20.

Note that in another embodiment, a separate valve may be used to control the flow to the drive nozzle(s) 62 than the spray nozzle 22. In this way, the amount of hover of glide can be controlled or turned off for certain applications.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. An undercarriage washer, comprising:
a handle;
a pipe connected to the handle;
a reaction driven maneuvering head connected to the pipe; and
a spray nozzle attached to the maneuvering head.

2. The washer of claim 1, wherein the reaction driven maneuvering head is a sphere.

3. The washer of claim 2, wherein the sphere is made of a low friction material.

4. The washer of claim 3, wherein the spray nozzle is essentially orthogonal to an inlet for the pipe in the maneuvering head.

5. The washer of claim 1, wherein the reaction driven maneuvering head has a drive nozzle.

6. The washer of claim 5, wherein the drive nozzle is essentially anti-parallel aligned with the spray nozzle.

7. The washer of claim 1, further including a trigger value incorporated into the handle.

8. The washer of claim 1, further including an additive container attached to the pipe.

9. An undercarriage washer, comprising:
a handle;
a trigger valve incorporated into the handle'
a pipe having a first end attached to the handle;
a reaction driven maneuvering head having an inlet attached to a second end of the pipe; and
a spray nozzle attached to the reaction driven maneuvering head.

10. The washer of claim 9, wherein the spray nozzle is formed into the reaction craven maneuvering head.

11. The washer of claim 9, wherein the reaction driven maneuvering head has a low friction contact surface.

12. The washer of claim 11, wherein reaction driven maneuvering head is a sphere.

13. The washer of claim 12, further including an additive container attached to the pipe.

14. The washer of claim 13, wherein the spray nozzle is essentially orthogonal to an inlet for the pipe in the maneuvering head.

15. The washer of claim 9, wherein the reaction driven maneuvering head has a drive nozzle.

16. The washer of claim 14, wherein the drive nozzle is essentially anti-parallel aligned with the spray nozzle.

17. The washer of claim 16, further including an additive container attached to the pipe.

18. The washer of claim 17, wherein the pipe has a “S” shape.
